(19) United States
(12) Patent Application Publication
(10) Pub. No.: US 2020/0042836 A1
(43) Pub. Date: Feb. 6, 2020

(54) INFORMATION PROCESSING DEVICE, INFORMATION PROCESSING SYSTEMS, AND PROGRAMS

(71) Applicant: RENESAS ELECTRONICS CORPORATION, Tokyo (JP)

(72) Inventor: Norio OKADA, Tokyo (JP)

(21) Appl. No.: 16/518,356

(22) Filed: Jul. 22, 2019

(30) Foreign Application Priority Data
Aug. 1, 2018 (JP) 2018-144706

(51) Int. Cl. G06K 9/62; G06N 3/08; G06N 7/00

(52) U.S. Cl. CPC G06K 9/6297; G06K 9/629; G06N 7/005; G06N 3/08

(57) ABSTRACT

The information processing device includes: a storage unit that stores model definition information defining a statistical model for each estimation type and an acquisition condition of a feature amount required for estimation using the statistical model; a data acquisition unit that acquires a feature amount from a sensor signal in a first mode according to the acquisition condition and acquires data for generating a new statistical model from a sensor signal in a second mode according to a condition different from the acquisition condition; a determination unit that determines whether the feature amount acquired by the data acquisition unit in the first mode satisfies a requirement defined by the model definition information; and a mode change unit that changes a mode from the first mode to the second mode according to a determination result that the feature amount does not satisfy the requirement.

### CROSS-REFERENCE TO RELATED APPLICATIONS

The disclosure of Japanese Patent Application No. 2018-144706 filed on Aug. 1, 2018 including the specification, drawings and abstract is incorporated herein by reference in its entirety.

### BACKGROUND

The present invention relates to an information processing device, an information processing system, and a program, for example, the present invention relates to an information processing device, an information processing system, and a program for performing estimation of states.

Techniques for estimating a state of an estimation target using a model and a signal from a sensor are known. In such techniques, it is required to utilize an appropriate model in order to make a correct estimation.

In Japanese unexamined Patent Application publication No. 2005-018389 (hereinafter, Patent Document 1), there is disclosed an abnormal preliminary diagnostic device having a sensor data acquisition means for acquiring the sensor data measured by a sensor installed in a mechanical equipment, a normal model generated by learning using the sensor data when the mechanical equipment is operating normally, and a data mining unit for diagnosing the presence or absence of an abnormal sign from the sensor data. In this anomaly sign diagnosing device, when the average daily temperature of the surroundings in which the mechanical equipment is installed changes to a predetermined value or more as compared with the case where the normal model was initialized last time, initialization instruction signals are outputted from the initialization instruction unit, and the normal model is reconstructed.

### SUMMARY

According to the technique described in Patent Document 1, it is possible to reconstruct the model when the external environment of the mechanical equipment fluctuates greatly. However, in the technique described in Patent Document 1, when the external environment largely fluctuates, the normal model is reconstructed using the acquired data similarly to the state estimation data. That is, this technique is only a technique for re-creating a new model for determining a normal state. Therefore, a model for detecting a new state is not created. Therefore, there is a need for a technique for creating a model for estimating a new state that cannot be estimated by an existing model.

Other objects and novel features will become apparent from the description of this specification and the accompanying drawings.

According to an embodiment, the information processing device has a data acquisition unit that acquires a feature amount from a sensor signal in a first mode according to an acquisition condition and acquires data for generating a new statistical model from a sensor signal in a second mode according to a condition different from the acquisition condition, and a mode change unit that changes a mode of the data acquisition unit from the first mode to the second mode according to a determination result that the feature amount acquired in the first mode does not satisfy a requirement defined by model defining information.

According to the embodiment, data for creating a model for estimating a new state that cannot be estimated by an existing model can be acquired.

### BRIEF DESCRIPTION OF THE DRAWINGS

FIG. 1 is a block diagram showing an exemplary configuration of an information processing device according to an outline of an embodiment.

FIG. 2 is a schematic diagram showing an example of a configuration of an information processing system according to an embodiment.

FIG. 3 is a block diagram showing an exemplary configuration of an estimation device according to an embodiment.

FIG. 4 is a table showing an example of the content of the database.

FIG. 5 is a schematic diagram illustrating a specific example of a statistical model used by an estimation device according to an embodiment.

FIG. 6 is a diagram showing an example of a definition of an observation state.

FIG. 7 is a block diagram illustrating an exemplary functional configuration of a presumptive device according to an embodiment.

FIG. 8 is a flow chart illustrating a flow of operation for a mode change in an estimation device according to an embodiment.

FIG. 9 is a block diagram illustrating an example of a hardware configuration of a server according to an embodiment.

FIG. 10 is a block diagram illustrating an example of a functional configuration of a server according to an embodiment.

FIG. 11 is a flow chart illustrating a flow of operation of a server according to an embodiment.

### DETAILED DESCRIPTION

For clarity of explanation, the following description and drawings are appropriately omitted and simplified. In the drawings, the same elements are denoted by the same reference numerals, and a repetitive description thereof is omitted as necessary.

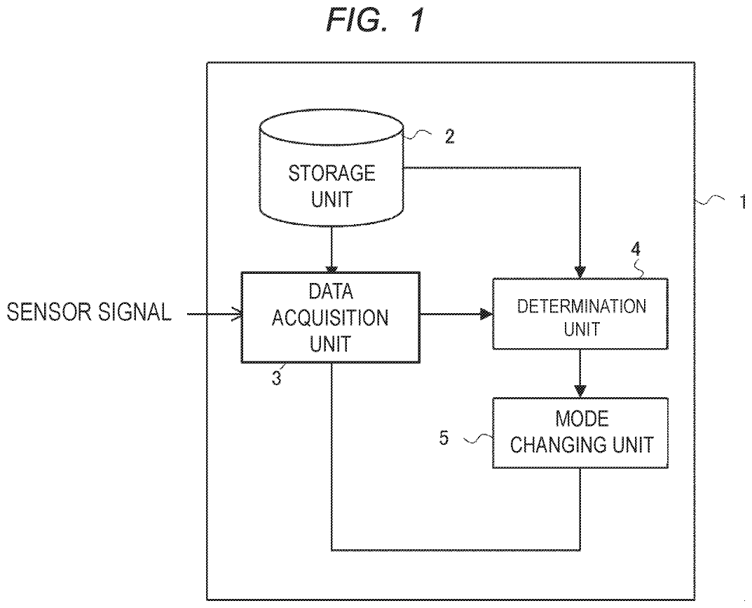

Prior to the detailed description of the embodiment, the outline of the embodiment will be described first. FIG. 1 is a block diagram showing an exemplary configuration of an information processing device 1 according to an outline of an embodiment of the present invention. As shown in FIG. 1, the information processing device 1 includes a storage unit 2, a data-acquiring unit 3, a determination unit 4, and a mode-changing unit 5.

The storage unit 2 stores model definition information defining a statistical model for each estimation type, and an acquisition condition of a feature amount required for estimation using the statistical model. The estimation type is a state that can occur in an estimation target, and is a type of a state of a determination target based on a statistical model. For example, when the estimation target is a living body such as a person, the estimation type may be the type of the disease. The object to be estimated is not limited to a person, but may be another living body such as an animal or a plant, or may be an object other than the living body. For example, the object to be estimated may be an artificial structure such as a device or a building. That is, the estimation target may be any object whose state changes. The storage unit 2 may store information on one statistical model or may store information on a plurality of statistical models. That is, for example, the storage unit 2 may store only information on a statistical model for estimating the disease A, or may store information on a statistical model for estimating the disease A and a statistical model for estimating the disease B. The statistical model represented by the model definition information is, for example, a hidden Markov model, but is not necessarily limited thereto. For example, it may be another statistical model such as a deep neural net.

The acquisition condition of the feature amount is a processing condition of an arbitrary process executed until the feature amount is acquired from the sensor signal. The acquisition condition may be, for example, a sampling rate or a minimum required quantization accuracy. The condition for acquiring the feature amount may be information for specifying a sensor used for acquiring the sensor signal. When the data subjected to the filtering process is used as the data for generating the new statistical models, that is, the data for learning, the obtaining condition may be a filtering condition.

The data acquisition unit 3 operates in one of two modes. In the first mode, the data acquisition unit 3 acquires the feature amount from the sensor signal in accordance with the acquisition condition stored in the storage unit 2. In the second mode, the data acquisition unit 3 acquires data for generating a new statistical model (i.e., learning data) from the sensor signal in accordance with a condition different from the acquisition condition used in the first mode. The conditions used in the second mode are at least partially different from the acquisition conditions used in the first mode. For example, only the sample rate may be different, or only the gain or filtering condition may be different.

The determination unit 4 determines whether or not the feature amount acquired by the data acquisition unit 3 in the first mode satisfies the requirement defined by the model definition information stored in the storage unit 2. Thereby, the determination unit 4 determines whether or not the acquired feature amount is a feature amount corresponding to the estimation by the existing statistical model.

The mode changing unit 5 changes the mode of the data acquisition unit 3 from the first mode to the second mode in accordance with the determination result by the determination unit 4 that the feature amount does not satisfy the requirement. That is, the mode changing unit 5 changes the mode of the data acquisition unit 3 from the first mode to the second mode in accordance with the determination result that the acquired feature amount does not correspond to the estimation based on the existing statistical model. The acquisition of the learning data is started by changing the mode by the mode changing unit 5. Here, the acquisition condition of the learning data is different from the acquisition condition of the feature amount required for estimation using an existing statistical model.

A new statistical model for estimating a new state that cannot be estimated by an existing statistical model may require data different from the data used in the existing statistical model. Even in such cases, according to the above-described information processing device 1, since data can be acquired under conditions different from the conditions for acquiring feature quantities required for estimation using an existing statistical model, a new statistical model for estimating a new state can be created. As described above, according to the information processing device 1, it is possible to acquire data for creating a model for estimating a new condition that cannot be estimated by a conventional model.

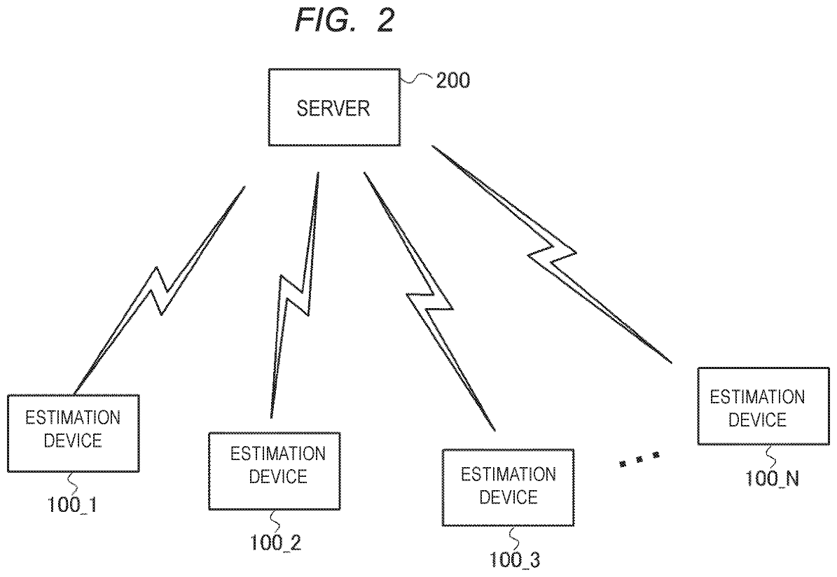

FIG. 2 is a schematic diagram showing an example of the configuration of the information processing system 10 according to the embodiment. As shown in FIG. 2, the information processing system 10 includes an estimation device 100_1, 100_2, 100_3, . . . , 100_N, and a server 200. In the following explanation, the estimation device 100_1, 100_2, 100_3, . . . , 100_N is referred to as the estimation device 100 when they are referred to without any particular distinction. In the example illustrated in FIG. 2, an N estimation devices (100_1, 100_2, . . . , 100_N) are illustrated, but the information processing system 10 may have one or more estimation device 100, which may be of any number. The estimation device 100 and the servers 200 are connected so as to be able to communicate with each other. The estimation device 100 and the servers 200 are connected so as to be able to communicate by radio communication, for example, but may be connected so as to be able to communicate by wired communication. In addition, a repeater may be present in the middle of the transmission path.

The estimation device 100 is a device corresponding to the information processing device 1 of FIG. 1. In the present embodiment, the estimation device 100 is a device that is worn on the human body and estimates the occurrence of a disease in the human body using statistical models. In present embodiment, hidden Markov models are used as examples of statistical models. Therefore, the computational load can be reduced as compared with the case of using other statistical models such as a deep neural net. The estimation device 100 is, for example, a wearable terminal, but may be another portable device such as a smartphone or a tablet terminal, or may be a non-portable device.

The server 200 is a device for updating a database used by the estimation device 100 for estimation, and the server 200 performs a process of generating a new statistical model using the learning data transmitted from the estimation device 100, as described later.

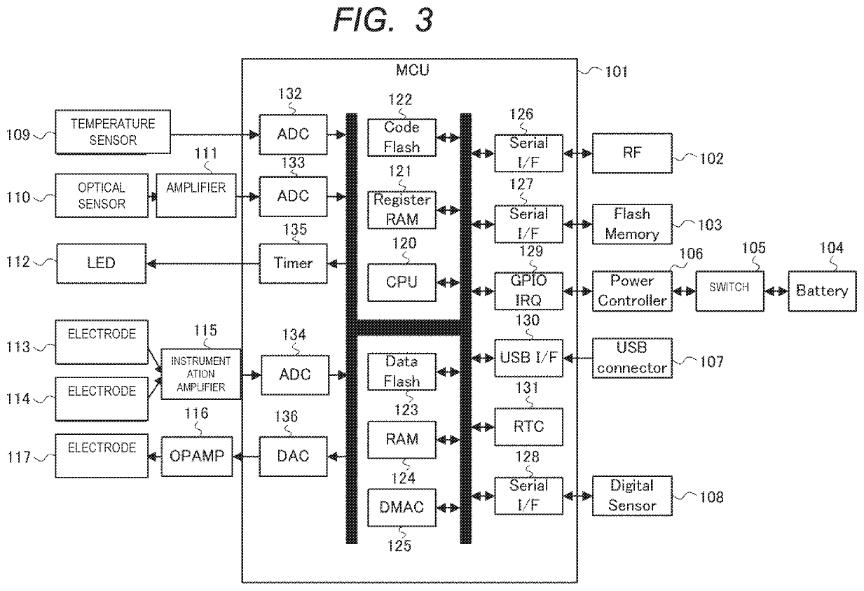

Next, the estimation device 100 will be described in detail. FIG. 3 is a block diagram showing an exemplary configuration of the estimation device 100. The estimation device 100 includes an MCU (Micro Controller Unit) 101 and external components of MCU 101. Specifically, the estimation device 100 includes RF circuits 102, flash memories 103, batteries 104, switches 105, power controllers 106, USB connectors 107, digital sensors 108, temperature sensors 109, optical sensors 110, amplifier amplifiers 111, LED112, electrodes 113, electrodes 114, instrumentation amplifiers 115, operational amplifiers 116, and electrodes 117 as components external to the MCU 101.

As shown in FIG. 3, the MCU 101 includes a CPU120, a register RAM 121, a code flash 122, a data flash 123, a RAM 124, a DMAC125, a serial I/F 126, 127, 128, a GPIO-IRQ129, a USB I/F 130, a RTC 131, ADC 132, 133, 134, a timer 135, and a DAC 136.

The CPU (Central Processing Unit) 120 is an exemplary processor for executing programs. The register RAM (Random Access Memory) 121 is a register group storing setting values and the like for controlling the MCU 101. The code flash 122 is a flash memory for storing a program. The data flash 123 is a flash memory for storing arbitrary data. In the present embodiment, the data flash 123 corresponds to the storage unit 2 of FIG. 1, and stores databases referred to for processes using statistical models. The RAM 124 stores work data such as intermediate process data at the time of executing programs. In the present embodiment, the RAM 124 stores time-series data and the like relating to sensor signals from various sensors. DMAC (Direct Memory Access Controller) 125 is a controller for transferring data without using a CPU 120.

The serial I/F 126 is an input/output interface between the RF circuit 102 and the MCU 101. The RF (Radio Frequency) circuit 102 is a transmission/reception circuit for the estimation device 100 to wirelessly communicate with another device. It is used for communication between the estimation device 100 and the servers 200. The serial I/F 127 is an input/output interface between the flash memory 103 and the MCU 101. The flash memory 103 is a flash memory external to the MCU 101, and stores any data outputted from the MCU 101. GPIO (General Purpose Input/Output)-IRQ (Interrupt Request) 129 is an interface for input and output of power between the battery 104 and the MCU 101, and an interface for communication between the MCU 101 and the power controller 106. The battery 104 stores electric power to be supplied to the respective components of the estimation device 100. The switch 105 is a switch for controlling supply and cut-off of electric power from the battery 104. For example, a user (estimated target) turning on switch 105 starts supplying power and starts operation of estimation device 100. The power controller 106 is a controller that manages the power supply. The power controller 106, for example, outputs an interrupt signal to the MCU 101 upon detection of an error in the battery 104. The USB I/F 130 is an input/output interface between the USB connector 107 and the MCU 101.

The USB (Universal Serial Bus) connector 107 is a connector for connecting a USB device (not shown) to the estimation device 100. The RTC (Real Time Clock) 131 provides a clock function. In present embodiment, an RTC 131 provides time information for grouping a plurality of sensor signals measured at the same time.

The serial I/F 128 is an input/output interface between the digital sensor 108 and the MCU 101. The digital sensor 108 is, for example, a digital sensor that measures a human body to be estimated or an environment surrounding the human body. The digital sensor 108 is, for example, a MEMS (Micro Electro Mechanical Systems) sensor, and includes an acceleration sensor, a gyro sensor, a barometric pressure sensor, and the like. For example, the acceleration sensor and the gyro sensor perform measurements for detecting movement of a human body. The digital sensor 108 inputs digital signals sampled at a sampling rate specified by a setting unit 161, which will be described later, to the MCU 101.

The ADC (Analog-To-Digital Converter) 132 converts the sensor signal (analog signal) outputted from the temperature sensor 109 into a digital signal at a sampling rate specified by a setting unit 161, which will be described later. The temperature sensor 109 is a sensor for measuring the temperature of the human body or the environment around the human body, and is configured by using, for example, a thermistor.

The timer 135 is a timer for controlling lighting of the LED112. The LED (Light Emitting Diode) 112 emits light for a predetermined period of time at predetermined timings under the control of the timer 135. The LED 112 emits light, for example, to a blood vessel of the human body. The ADC 133 converts a sensor signal (analog signal) outputted from the optical sensor 110 and amplified by the amplifier 111 into a digital signal at a sampling rate specified by a setting unit 161 (described later). The amplifier 111 is an amplifier for amplifying a sensor signal output from the optical sensor 110. The optical sensor 110 is configured using, for example, a phototransistor or a photodiode, and is used to measure blood flow or the like by utilizing the characteristic of hemoglobin absorbing light. For example, the optical sensor 110 detects the reflected light of the green light emitted by the LED 112, which is reflected by the body tissue. The intensity of the light detected by the light sensor 110 varies according to the blood flow. Therefore, the pulse can be measured by the sensor signal from the optical sensor 110.

The ADC 134 converts the sensor signal (analog signal) output from the electrode 113 and amplified by the instrumentation amplifier 115, and the sensor signal (analog signal) output from the electrode 114 and amplified by the instrumentation amplifier 115, into a digital signal at a sampling rate specified by a setting unit 161 described later. The instrumentation amplifier 115 is an amplifier for amplifying the sensor signals output from the electrodes 113 and 114. The electrodes 113 and 114 contact the human body, detect an electric signal in the human body, and output the detected electric signal to the instrumentation amplifier 115 as a sensor signal. A digital-to-analog converter (Digital-To-Analog Converter) 136 converts a digital signal for generating an electric signal (analog signal) outputted from the electrodes 117 into an analog signal. The operational amplifier 116 is an amplifier for amplifying analogue signals outputted from the DAC 136. The electrode 117 contacts the human body and outputs the electric signal output from the operational amplifier 116 to the human body. The electrodes 113, 114, and 117, the instrumentation amplifier 115, the operational amplifier 116, the ADC 132, and the DAC 136 are used, for example, as configurations for obtaining electrocardiographic waveforms. In this case, the DAC 136, the operational amplifier 116, and the electrodes 117 are AC wave generating circuits for measuring impedances in the body. The electrodes 113, 114, and 117, the instrumentation amplifier 115, the operational amplifier 116, the ADC 132, and the DAC 136 may be used, for example, as a configuration for measuring impedances in the body. That is, these components may be used as a body composition meter. In this case, the DAC 136, the operational amplifier 116, and the electrodes 117 function as a structure for allowing a current of a predetermined frequency to flow to the human body.

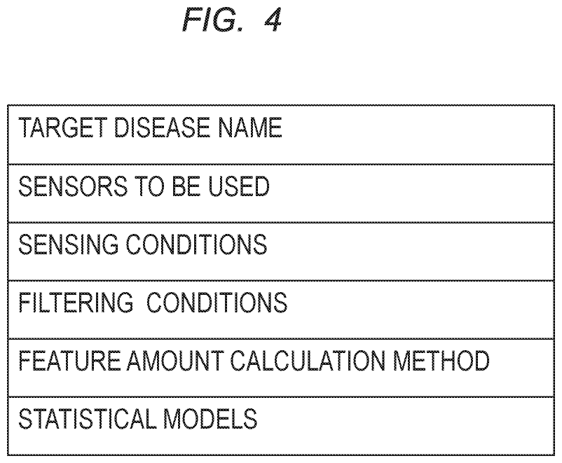

Next, a database stored in the data flash 123 will be described. As described above, the data flash 123 corresponds to the storage unit 2 of FIG. 1, and stores the model definition information defining the statistical model for each estimation type, and the acquisition condition of the feature amount required for the estimation using the statistical model. The database is not limited to the data flash 123, and the database may be stored in another storage device such as the flash memory 103. FIG. 4 is a table showing an example of the contents of the database. In the present embodiment, the databases manage information as shown in FIG. 4 for each disease to be estimated. Specifically, the database manages “target disease name”, “sensors to be used”, “sensing conditions”, “filtering conditions”, “feature amount calculation methods”, and “statistical models” for each disease to be estimated. The database also manages this information for physical conditions in which no disease has occurred. That is, the database manages these pieces of information for each estimation type.

The “target disease name” is information indicating the name of a disease to be estimated by a statistical model. As for the physical condition in which the disease does not occur, for example, the expression “the target disease name” is “no abnormality”. The “sensor to be used” is information indicating which sensor signal is required for the estimation of the disease. That is, it is information that identifies one or more sensors needed for the estimation of the disease. In present embodiment, digital sensors 108, temperature sensors 109, optical sensors 110, and electrodes 113, 114, which are sensors that generate sensor signals, may be specified. The “sensor to be used” may also be referred to as sensor specifying information. The “sensing condition” is information for specifying, for each sensor, a measurement condition at the time of measurement by the sensor specified in the “sensor to be used”. The “sensing condition” is, for example, a sampling rate, but may be quantization accuracy.

The “filtering condition” is information that specifies the filtering condition of the filtering process to be performed on the data obtained based on the sensor signals from the sensors specified in the “sensor to be used”. The “filtering condition” is specified for each sensor as the “target disease name”. The filtering condition may be, for example, a filtering scheme, a filtering order, or filtering coefficients. The “feature amount calculation method” is information defining a calculation method of a feature amount required for estimation of the disease.

The “statistical model” is model definition information which is information defining a statistical model for estimation of the disease. The model definition information includes information defining a range of the feature amount according to the estimation type. By the way, in the present embodiment, since the estimation device 100 performs estimation using the hidden Markov model as a statistical model, the statistical model has one or more inner states (observation states) (observation states). Therefore, in the present embodiment, the model definition information includes, in more detail, information defining the range of the feature amount for each inner state (observation state) as information defining the range of the feature amount according to the estimation type. The model definition information includes information defining a transition probability of an internal state.

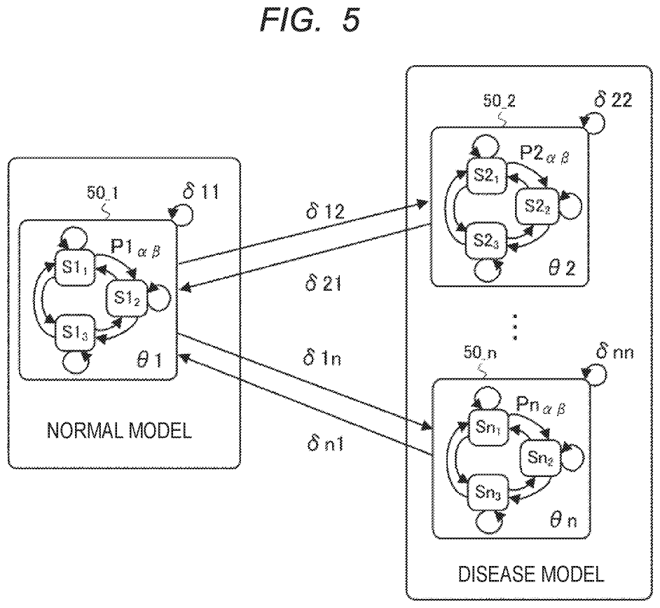

Specific examples of statistical models used by the estimation device 100 will now be described. FIG. 5 is a schematic diagram showing specific examples of statistical models used by the estimation device 100. In the schematic diagram shown in FIG. 5, n statistical models are shown. The statistical model 50_1 is a statistical model (normal model) simulating a state in which the body is normal. The statistical models 50_2 to 50_n are statistical models (disease models) simulating a state in which any disease has occurred in the body. For example, the statistical model 50_2 is a statistical model that mimics the state in which the disease A occurred, and the statistical model 50_n is a statistical model that mimics the state in which the disease B occurred.

The statistical model 50_i, where i is an integer greater than or equal to 1 and less than or equal to n, has a potential state Gi. The latent state Gi has an observed state Si_k. Where k is an integer greater than or equal to 1. In the example shown in FIG. 5, the statistical models 50_1, 50_2, . . . , 50_n each have three observation states (i.e., k=3), but this is for the convenience of illustration, and the number of observation states is actually an appropriate number for each statistical model. δxy, where x and y are each integers greater than or equal to 1 and less than or equal to n, indicates the transition probability from the latent state Ox to the latent state By.

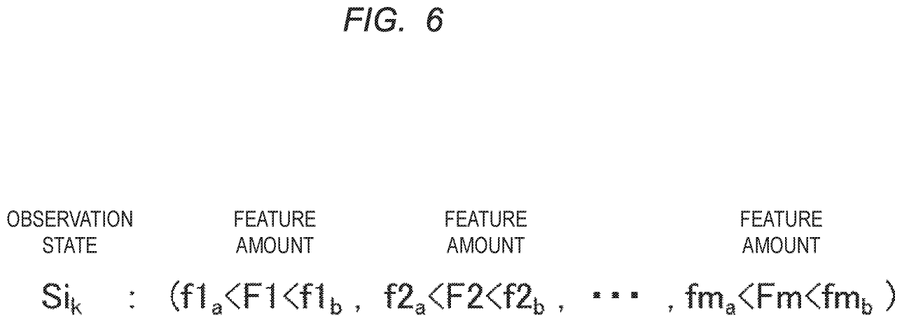

As shown in FIG. 6, one or more types of feature amounts and ranges for each feature amount are defined in the observed state Si_k. In the case shown in FIG. 6, m types of feature amounts F1 to Fm are associated with the observed state Si_k. In addition, a value range is set for each feature amount. According to such definitions, for example, when the feature amounts F1, . . . , Fm satisfy f1a<F1<f1b, f2a<F2<f2b, . . . , fma<Fm<fmb, the state of the estimation target person belongs to the observed state Si_k. Here, the observed state Si_k may define a plurality of types of feature quantities obtained from one sensor. For example, simultaneous feature amounts obtained from the same sensor through a different filtering may be associated with the same observation-state Si_k. More specifically, for example, the estimation of the disease may be performed using a feature amount (specifically, light intensity) obtained by extracting a signal of a predetermined frequency or less from one sensor (for example, an optical sensor) by LPF (Low Pass Filter), a feature amount (specifically, light intensity) obtained by extracting a signal of a predetermined frequency band by BPF (Band Pass Filter), and a feature amount represented by a ratio of the two feature amounts (light intensity values). The feature amount and the value range thereof associated with the observed state Si_k are defined for each observed state. The information defining these corresponds to the information defining the range of the feature amount for each observation state in the model definition information. In the statistical model 50_i, the state transition probability Pi_αβ of the observed state Si_k in the same statistical model is also defined as model definition information. Here, the Pi_αβ indicates the transition probability from the observation state Si_α to the observation state Si_β. Here, α and β are integers of 1 or more, respectively, in the example shown in FIG. 5, α and β are integers of 1 or more and 3 or less, respectively. For example, when the statistical model 50_1 is described as an example, the state transition probability P1_11 from the observation state S1_1 to the observation state S1_1 and the state transition probability P1_12 from the observation state S1_1 to the observation state S1_2 are defined.

In the hidden Markov model, it is estimated to which potential state θi the present state belongs by specifying the observation state Si_k from the observed features. As a result, the estimation device 100 estimates which condition the estimation target person is currently in. That is, the estimation device 100 estimates whether the estimation target person is in a normal state or in a state in which any disease has occurred.

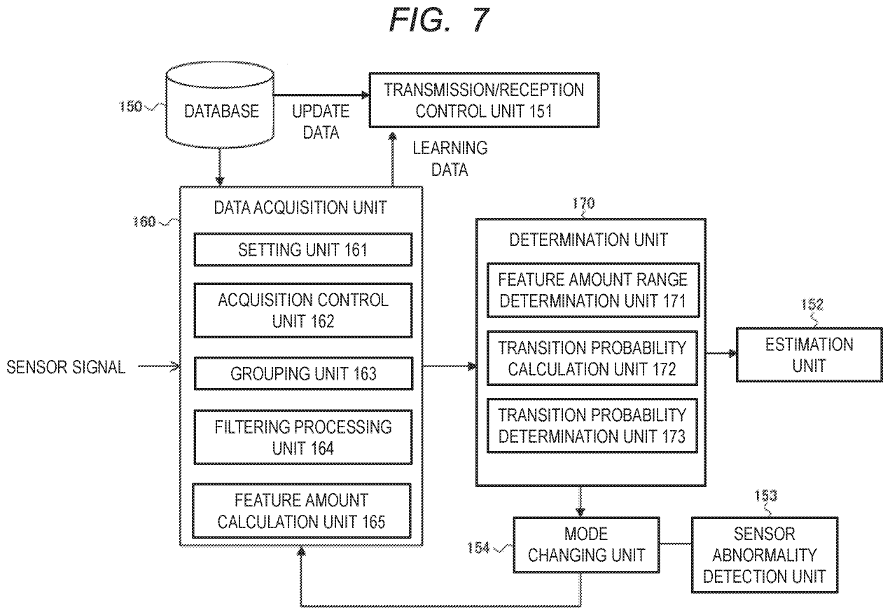

Next, the functional configuration of the estimation device 100 will be described. FIG. 7 is a block diagram showing an exemplary functional configuration of the estimation device 100. As shown in FIG. 7, the estimation device 100 includes a database 150, a transmission/reception control unit 151, a data obtaining unit 160, a determination unit 170, an estimation unit 152, a sensor anomaly detecting unit 153, and a mode changing unit 154. The constituent elements shown in FIG. 7 are realized by, for example, a CPU120 executing programs including one or more instructions.

The database 150 is a database referred to for processing using a statistical model, and manages information as shown in FIG. 4. That is, the database 150 manages the model definition information of the statistical model and the acquisition condition of the feature amount for each estimation type. The database 150 is updated with the update data received from the server 200. For example, the database 150 updates information for estimating a new disease based on the update data.

The transmission/reception control unit 151 controls transmission/reception of data between the estimation device 100 and the servers 200. For example, the transmission/reception control unit 151 receives the update data transmitted from the server 200 via the RF circuit 102, and registers the update data in the database 150. That is, the transmission/reception control unit 151 registers the update data of the database 150. The transmission/reception control unit 151 may also be referred to as a registration unit. Updating the database 150 allows estimation by a new model. When the received update data is encrypted, the transmission/reception control unit 151 performs decryption processing and registers it in the database 150. The transmission/reception control unit 151 may perform a falsification detection process, or may not register the falsification in the database 150 when the falsification is detected.

In addition, the transmission/reception control unit 151 controls to transmit the learning data acquired by the data acquisition unit 160 to the server 200 via the RF circuit 102. Therefore, the server 200 can acquire data for model generation. When transmitting the learning data, the transmission/reception control unit 151 may transmit the learning data after encrypting the learning data using any encryption algorithm such as AES (Advanced Encryption Standard).

The data acquisition unit 160 corresponds to the data acquisition unit 3 in FIG. 1, and includes a setting unit 161, an acquisition control unit 162, a grouping unit 163, a filtering processing unit 164, and a feature amount calculation unit 165. In the estimation mode, the data acquisition unit 160 acquires data in accordance with conditions defined in the database 150. On the other hand, in the collection mode, data is acquired in accordance with a predefined condition for collecting data for generating a new statistical model, that is, learning data.

The setting unit 161 sets the measurement conditions of the sensors so as to satisfy all the “sensing conditions” registered in the database 150. When a necessary sampling rate for each estimation type is specified as the sensing condition, the least common multiple of the sampling rate specified by each sensing condition is set as the actual measurement condition for sampling of a certain sensor signal. That is, for example, when 50 Hz sampling for estimation of the disease A is defined in the sensing condition and 60 Hz sampling for estimation of the disease B is defined in the sensing condition for a certain sensor signal, the setting unit 161 sets 300 Hz, which is the least common multiple of these, as the sampling rate of the sensor signal. Further, when there is an instruction to change the mode from the mode changing unit 154 described later, the setting unit 161 changes the measurement condition to a predefined measurement condition for acquiring learning data.

The acquisition control unit 162 controls to acquire sensor data, which is digital data after sampling of the sensor signal, in accordance with the setting of the setting unit 161. For example, upon receiving an instruction from the user, the acquisition control unit 162 controls to start acquisition of sensor data.

The grouping unit 163 groups sensor data groups sampled at the same time. Since the sensor data is continuously sequentially acquired, grouped sensor data groups are sequentially accumulated. That is, they form time series data. The grouped sensor data groups are sequentially stored in the RAM 124 as time-series data.

The filtering processing unit 164 performs filtering processing according to the estimated type on each sensor data in accordance with the “filtering condition” of the database 150. Sensor data may include various noises as well as signals that are valuable for estimation in statistical models. Note that the term “noise” herein refers to a signal which, when attention is paid to the estimation in a certain statistical model, prevents an appropriate estimation in performing the estimation in the statistical model. That is, the signal to be regarded as noise differs depending on the estimation type. Therefore, as described above, the database 150 holds the “filtering condition” corresponding to the estimated type. This enables filtering calculations suitable for statistical models corresponding to the estimated types. For example, in the determination of stress or the like, studies on fluctuations in electrocardiographic waveforms are known, and according to the results of such studies, it is desirable to calculate fluctuations in the time interval of the R wave in order to determine the state of the body. Since the P wave, the Q wave, the S wave, and the T wave may be treated as noises, it is desired to register filtering for securing the peak of the R wave in the database 150 and to calculate the peak interval of the R wave reliably. On the other hand, since the rise times of the R waves tend to be caused by heart diseases, it is desirable to register filtering for correctly obtaining the differential coefficients in the database 150 in order to estimate such diseases.

The feature amount calculation unit 165 calculates feature amounts required for the respective statistical models from the sensor data after the filtering process in accordance with the “feature amount calculation methods” of the database 150. The sensor data is, for example, a numerical value obtained by analog-to-digital conversion of a voltage value. Such values are not biologically or physically meaningful. Therefore, the feature amount calculation unit 165 converts the sensor data into a biologically or physically meaningful value, that is, a feature amount. For example, when the time-series data of the sensor data is desired to be subjected to frequency analysis, it is effective to perform fast Fourier transform, weblet transform, or the like to calculate the feature amount. For the sensor data of the acceleration sensor, for example, normalization using gravitational acceleration as a 1G is performed on the sensor data, and then a product of the normalized value and the body weight is calculated, and this is used as a feature amount indicating the activity amount.

In the present embodiment, the feature amount calculation unit 165 calculates one or more feature amounts from one or more sensor signals. In the case where the feature amount calculation unit 165 calculates a plurality of feature amounts, it is possible to estimate a more diverse estimation type as compared with the estimation using only one feature amount. Further, when calculating a certain feature amount, the feature amount calculation unit 165 may calculate the feature amount from a plurality of sensor signals measured at the same time grouped by the grouping unit 163. In this case, it is possible to perform estimation using the feature amount reflecting the correlation between the sensor signals. In addition, the feature amount calculation unit 165 may calculate one feature amount from one sensor signal. In this case, the amount of computation and the filtering designing can be reduced in some cases as compared with the case where the feature amount is calculated by focusing on the mutual relation of a plurality of types of sensor signals. That is, current consumption can be expected to be suppressed.

Next, the determination unit 170 will be described. The determination unit 170 corresponds to the determination unit 4 in FIG. 1, and includes a feature amount range determination unit 171, a transition probability calculation unit 172, and a transition probability determination unit 173. With these configurations, the determination unit 170 determines whether or not data for generating a new statistical model, that is, learning data, needs to be collected.

The feature amount range determination unit 171 determines whether or not the feature amount calculated by the feature amount calculation unit 165 satisfies the range of the feature amount of one of the observed states Si_k according to the model-definition information of the database 150. That is, the feature amount range determination unit 171 determines whether or not the latest feature amount obtained from the estimation target person belongs to one of the observation states Si_k. As described above, the feature amount range determination unit 171 provides a function of determining whether or not the feature amount acquired by the data acquisition unit 160 is within the range defined by the model definition information. When the state of the estimation target person can be estimated by the existing information of the database 150, the feature amount belongs to any observation state Si_k.

The transition probability determination unit 173 determines whether or not the transition probability between the observation states is a reasonable value when the feature amount range determination unit 171 determines that the latest feature amount obtained from the estimation target person belongs to any observation state Si_k. Specifically, the transition probability determination unit 173 compares the transition probability from the observation state Si_k to which the feature amount is determined to belong at the previous determination timing by the feature amount range determination unit 171 to the observation state Si_k to which the feature amount is determined to belong at the present determination timing with the transition probability defined in the model definition information of the database 150, and determines that the transition probability is a reasonable value when the amount of deviation between the two model definition information is less than a predetermined threshold.

In the following explanation, a transition probability from the observation state Si_k determined to belong to the feature amount at the previous determination timing to the observation state Si_k determined to belong to the feature amount at the present determination timing is referred to as an observation transition probability. The transition probability defined in the model definition information of the database 150 is referred to as a defined transition probability.

More specifically, the transition probability determination unit 173 determines the degree of coincidence between the observed transition probability and the defined transition probability. That is, the transition probability determination unit 173 determines whether or not the difference between the observed transition probability and the defined transition probability is equal to or less than a predetermined allowable value. When the state of the estimation target person can be estimated by the existing information of the database 150, the difference between the observed transition probability and the defined transition probability becomes equal to or less than a predetermined allowable value.

The observed transition probability is calculated by the transition probability calculation unit 172. The transition probability calculation unit 172 calculates the observed transition probability based on the time-series data of the feature amount acquired by the data acquisition unit 160 during the predetermined period T. The time-series data of the feature amount acquired during the predetermined period T is time-series data of the feature amount including the latest feature amount acquired by the data acquisition unit 160. More specifically, the transition probability calculation unit 172 calculates the occurrence frequency of the transition coinciding with the latest state transition in the predetermined period T from the time series data of the observed state Si_k to which each of the feature amounts included in the time series data of the feature amount belongs. Then, the transition probability calculation unit 172 sets the calculated occurrence frequency as the observed transition probability. The transition-probability calculation unit 172 specifies the observed-state Si_k to which the feature amounts included in the time-series data belong, for example, by using the determination result of the feature-amount-range determination unit 171.

The calculation of the observed transition probability will be further described with reference to a specific example. For example, let F(t) be a set of values of time t of a feature amount group composed of m types of feature quantities F1, F2, . . . , Fm. It is also assumed that the predetermined period T described above is from time t1 to time t5. Further, it is assumed that the observation state to which the set F(t1) belongs is the observation state S 1 1 shown in FIG. 5, the observation state to which the set F(t2) belongs is S1_2, the observation state to which the set F(t3) belongs is S1_2, the observation state to which the set F(t4) belongs is S1 1, and the observation state to which the set F(t5) belongs is S1_2. Here, for simplicity of description, the number of transitions in the predetermined period T is assumed to be four in total, but by increasing the number of transitions in the predetermined period T, it is possible to calculate the observation transition probability more accurately. In this case, the set F(t5) is the latest feature amount, and the observation state is the observation transition probability for which the transition probability from the S1_1 to the observation state S1_2 is to be calculated. In this instance, the total number of occurrences of the transition within the predetermined period is 4, and of these, the transition from the observation state S1_1 to the observation state S1_2 occurs twice. Therefore, in this case, the observed transition probability is 0.5. The above-described calculation method is an example, and the transition probability determination unit 173 may calculate the observed transition probability using another calculation method.

The estimation unit 152 performs estimation based on the statistical model defined in the database 150 and the feature amount acquired by the data acquisition unit 160. The estimation unit 152 estimates the state of the estimation target person by estimating which potential state Gi the state of the estimation target person belongs to based on the determination results by the feature amount range determination unit 171 and the transition probability determination unit 173. More specifically, the estimation unit 152 estimates the state of the estimation target person based on the transition probability δxy calculated from the time-series data of the estimation result. Referring to FIG. 5, for example, when the calculated transition probability δnn exceeds a predetermined threshold, the estimation unit 152 estimates that the disease B corresponding to the statistical model 50_n has occurred. The estimation device 100 can provide an estimation result by the process of the estimation unit 152. In this manner, in the present embodiment, the estimation unit 152 estimates the occurrence of the disease of the human body based on the statistical models 50_1 to 50_n which are models for each type of the disease, but may estimate the occurrence of the disease in another living body other than the human body.

The statistical model may also be input with feature quantities based on ungrouped sensor signals. In order to perform grouping, it is necessary to prepare sampling data of each sensor signal on the basis of the maximum sampling rate among the sampling rates required for calculating the feature amount for each of the sensor signals to be grouped. Thus, among the grouped sensor signals, there may be sensor signals that require more sampling than necessary. Alternatively, instead of increasing the number of samples, it is required to complement the data. Therefore, when grouping is not performed, such redundant processing can be avoided. On the other hand, when the feature amount based on the grouped sensor signals is input to the statistical model, it is possible to estimate a state in which a plurality of types of sensor signals are considered, so that a more complicated state can be estimated.

The sensor abnormality detection unit 153 detects abnormalities in the sensors, i.e., the digital sensor 108, the temperature sensor 109, the optical sensor 110, and the electrodes 113 and 114. For example, when there is no change in the time-series data of the sensor data, the sensor abnormality detection unit 153 determines that an abnormality has occurred in the sensor for acquiring the sensor data. The method of determining the abnormality is not limited to this, and the abnormality may be detected by another method.

The mode changing unit 154 corresponds to the mode changing unit 5 of FIG. 1, and changes the operation mode of the data acquisition unit 160 from the estimation mode to the collection mode when data collection for generating a new statistical model is necessary. The mode changing unit 154 changes the mode from the estimation mode to the collection mode when the feature amount range determination unit 171 determines that the feature amount acquired by the data acquisition unit 160 does not belong to any observation state Si_k. Note that the mode changing unit 154 may change the mode as soon as the feature amount range determination unit 171 determines that the feature amount acquired by the data acquisition unit 160 does not belong to any observation-state Si_k, or may change the mode when such a determination result frequently occurs. That is, the mode changing unit 154 may change from the estimation mode to the collection mode when the ratio of the determination result that the feature amount is not within the range among all the determination results obtained by the feature amount range determination unit 171 with respect to the time-series data of the feature amount in the predetermined period T′ satisfies a predetermined criterion. According to such a configuration, the mode change timing can be appropriately determined without being influenced by the determination result suddenly generated due to disturbance or the like.

When the transition probability determination unit 173 determines that the observed transition probability is not a reasonable value, that is, when the difference between the observed transition probability and the defined transition probability exceeds a predetermined allowable value, the mode change unit 154 changes the mode from the estimation mode to the collection mode. Note that the mode changing unit 154 may not be affected by the sudden determination result in the same manner as described above even in the case of changing the mode based on the determination result by the transition probability determination unit 173. That is, the mode changing unit 154 may change the mode when the occurrence frequency of a situation in which the difference from the defined transition probability exceeds a predetermined allowable value satisfies a predetermined criterion by the transition probability determination unit 173.

However, in present embodiment, the mode changing unit 154 changes the operation mode from the estimation mode to the collection mode in accordance with the determination result of the determination unit 170 only when no sensor anomaly is detected. When the reason why the feature amount not corresponding to the existing statistical model is obtained is not because the feature amount corresponding to the new disease is obtained but because the inappropriate feature amount caused by the failure of the sensor is obtained, it is unnecessary to collect the learning data. Therefore, the mode changing unit 154 does not change the mode when an abnormality of the sensor is detected. This suppresses unnecessary mode changes. In the present embodiment, the mode is changed only when the abnormality of the sensor is not detected, but the mode may be changed regardless of the presence or absence of the abnormality of the sensor.

The mode changing unit 154 notifies the data acquisition unit 160 of the mode change. Thereby, the data acquisition unit 160 acquires learning data for generating a new statistical model capable of estimating the state of the estimation target person, which cannot be estimated by the existing statistical model, in accordance with a predetermined dedicated condition for acquiring learning data. The learning data acquired by the data acquisition unit 160 in the collection mode may be sampled digital data (digital data before grouping by the grouping unit 163), grouped digital data, or digital data after processing by the filtering processing unit 164.

The above-mentioned dedicated condition may be, for example, information indicating sampling at a sampling rate different from the sampling rate of the sensor signal set in the estimation mode. In this case, the data acquisition unit 160 in the collection mode samples the sensor signal at the sampling rate specified by the dedicated condition. For example, the sampling rate in the collection mode is a maximum value that can be set. The sampling rate may be larger than the sampling rate in the estimation mode instead of the maximum value.

According to an instruction from the mode changing unit 154, the data acquisition unit 160 sets an acquisition condition different from the acquisition condition in the estimation mode, but the acquisition condition is not limited to the sampling rate. For example, the obtaining condition changed by changing the modes may be filtering. For example, some or all of the filtering processes applied in the estimation mode may not be applied in the collection mode. As described above, the processing content of the filtering processing may be different between the estimation mode and the collection mode.

In this manner, the mode changing unit 154 instructs the data acquisition unit 160 to change the acquisition condition. As a result, raw data (raw data) obtained from the estimation target person, the vicinity thereof, and the like can be obtained, so that more useful data can be obtained as learning data for new generation of the statistical model.

The data acquisition unit 160 in the collection mode continuously acquires the learning data for a preset collection period. The transmission/reception control unit 151 transmits the acquired learning data to the server 200. For example, the transmission/reception control unit 151 may collectively transmit the learning data accumulated in the RAM124 to the server 200 at predetermined transmission timings, or may sequentially transmit the acquired learning data to the server 200. In order to avoid wasteful communication standby, it is preferable that the communication timing of the estimation device 100 is aligned with the communication timing of the servers 200.

When there is an instruction from the server 200, the data acquisition unit 160 may acquire the learning data continuously during the collection period instructed from the server 200, instead of the collection period set in advance. The data acquisition unit 160 may be set to the collection mode by an instruction from the server 200, in addition to being set to the collection mode by the mode change unit 154. The data acquisition unit 160 may acquire the learning databased on the acquisition condition specified by the server 200.

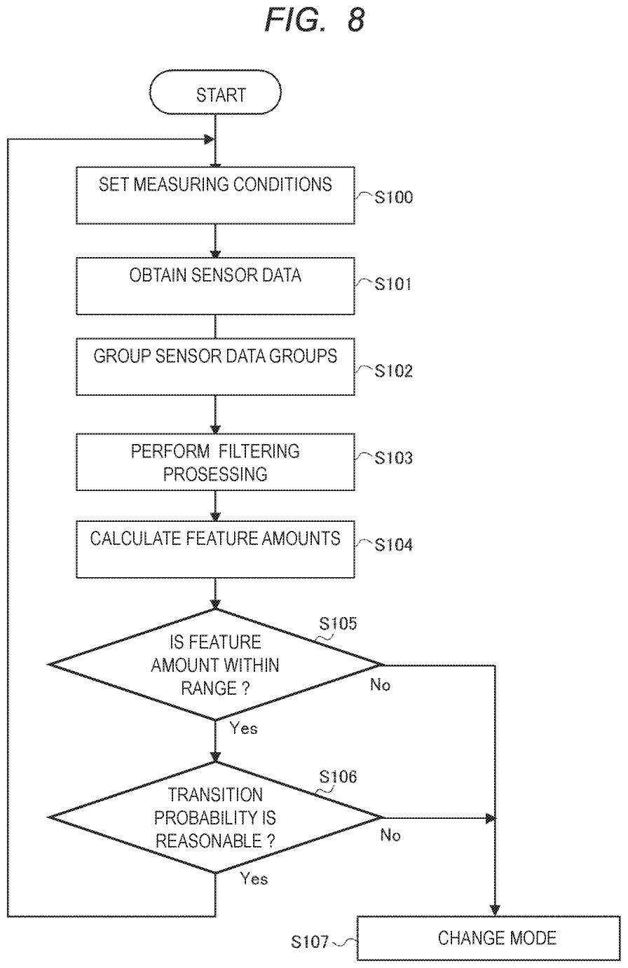

Next, the flow of the operation for changing modes in the estimation device 100 will be described. FIG. 8 is a flow chart showing the flow of the operation for changing modes in the estimation device 100. Hereinafter, the flow of the operation will be described with reference to FIG. 8.

In S100, the setting unit 161 refers to the database 150 and sets the measuring conditions of the sensors so as to satisfy the sensing conditions. It should be noted that not all of the sensors included in the estimation device 100 are used for measurements. The setting unit 161 may refer to the database 150 and set the measurement conditions only for the sensors necessary for the measurement. In this instance, of the sensors included in the estimation device 100, the power supplied to the sensors that are not necessary for measurements in accordance with the database 150 may be limited. That is, the estimation device 100 may have a function of restricting the power supplied to the sensor that is not necessary. For example, such a sensor may not be powered on. For example, the setting unit 161 may refer to the database 150, determine unnecessary sensors, and output a control signal for limiting power supplied to them. According to such a configuration, power consumption can be reduced. Next, in step 101 (S101), the acquisition control unit 162 controls to obtain sensor data in accordance with the setting in step 100. Next, in S102 102, the grouping unit 163 groups the sensor data groups at the same time. Next, in step 103 (S103), the filtering processing unit 164 performs filtering processing according to the estimation type for each sensor data referring to the database 150. Next, in step 104 (S104), the feature amount calculation unit 165 refers to the database 150, and calculates feature amounts required for the statistical models from the sensor data after the filtering process.

Next, in step 105 (S105), the feature amount range determination unit 171 refers to the model definition information of the database 150, and determines whether or not the feature amount calculated in step 104 satisfies the range of the feature amount defined for any observation-state Si_k. When the calculated feature amount satisfies the defined ranges, that is, when the observed-state Si_k corresponding to the calculated feature amount is defined (YES in step 105), the process proceeds to step 106. When the observation-state Si_k corresponding to the calculated feature amount is not defined (NO in step 105), the process proceeds to step 107.

In step 106 (S106), the transition probability determination unit 173 refers to the model definition information in the database 150, and determines whether the transition probability between the observed states is a reasonable value. If the transition probability is a reasonable value (Yes in step 106), no mode change is made. That is, the estimation mode continues. In this case, the determination flow of whether or not the mode needs to be changed (steps 100 to 106) is repeated. If the transition probability is not a reasonable value (No in step 106), the process proceeds to step 107.

In step 107 (S107), the mode changing unit 154 confirms that an anomaly of the sensor has not been detected, and changes the operation mode of the data acquisition unit 160 from the estimation mode to the collection mode. The mode changing unit 154 may change the mode without checking whether or not an abnormality of the sensor is detected. It should be noted that in the above-mentioned flowchart, the process immediately proceeds to step 107 when the result of step 105 or step 106 is No, but as described above, the process may proceed to step 107 when the occurrence frequency of the event that becomes No satisfies a predetermined criterion. When the mode is changed, the setting unit 161 changes the measurement conditions to the measurement conditions for acquiring learning data. As a result, acquisition of the learning data is started.

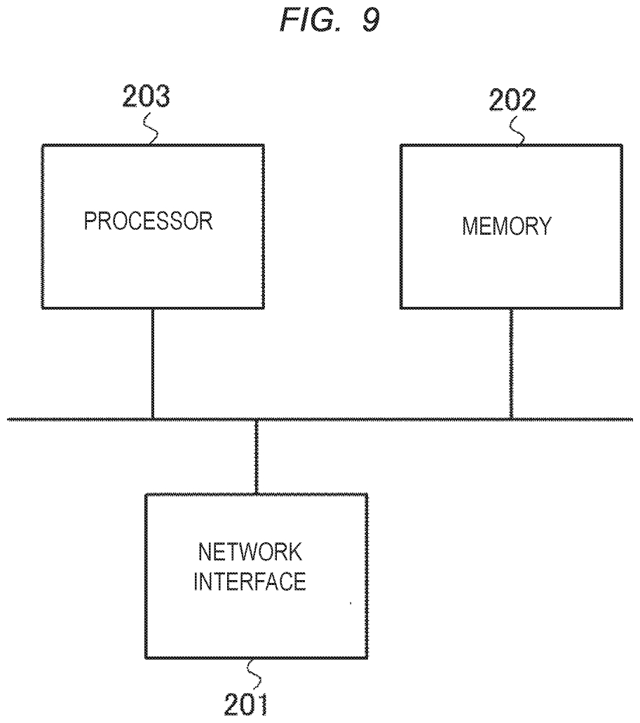

Next, the server 200 will be described. FIG. 9 is a block diagram showing an example of the hardware configuration of the server 200. As shown in FIG. 9, the server 200 includes, for example, a network interface 201, a memory 202, and a processor 203.

The network interface 201 is used to communicate with the estimation device 100. The network interface 201 may include, for example, a network interface card NIC.

The memory 202 is composed of, for example, a volatile memory or a nonvolatile memory. The memory 202 is used to store, for example, a program including one or more instructions to be executed by the processor 203.

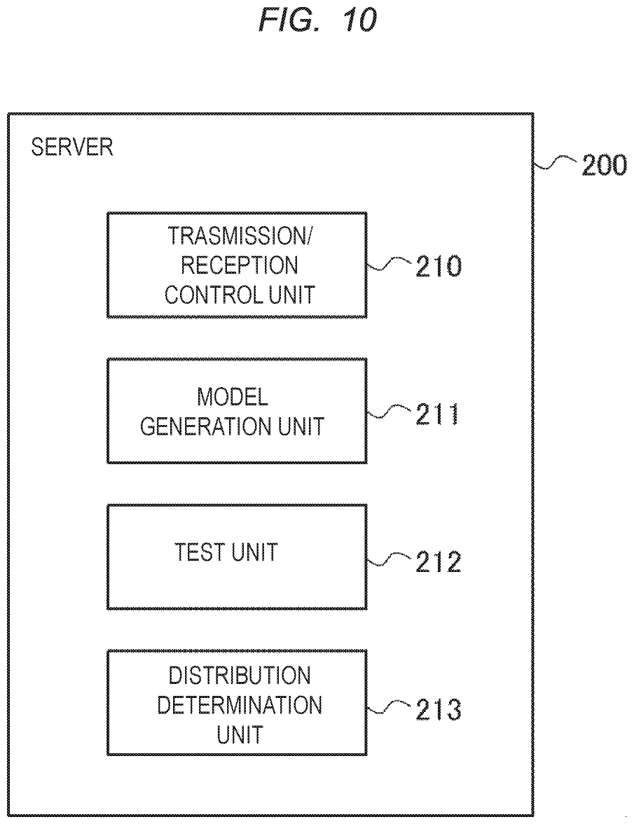

The processor 203 may be, for example, a microprocessor, an MPU (Micro Processor Unit), a CPU (Central Processing Unit), or the like. The processor 203 may include a plurality of processors. The processor 203 reads and executes a computer program from the memory 202, thereby performing processing of each component of the server 200 shown in FIG. 10.

FIG. 10 is a block diagram showing an example of the functional configuration of the server 200. As shown in FIG. 10, the server 200 includes a transmission/reception control unit 210, a model generation unit 211, a test unit 212, and a distribution determination unit 213.

The transmission/reception control unit 210 controls transmission/reception of data between the servers 200 and the estimation device 100. For example, the transmission/reception control unit 210 receives the learning data transmitted from the estimation device 100 via the network interface 201, and stores the learning data in the memory 202. When the learning data received from the estimation device 100 is encrypted, the transmission/reception control unit 210 performs a decryption process. Further, the transmission/reception control unit 210 controls to transmit the updated data to be registered in the database 150 of the estimation device 100 to the estimation device 100 via the network interface 201.

The model generation unit 211 uses the learning data received from the estimation device 100, that is, the data acquired by the data acquisition unit 160 in the collection mode, to generate a new statistical model. The model generation unit 211 performs pre-processing on sensor data designated in advance among various types of sensor data included in the received learning-use data in accordance with sensing conditions, filtering conditions, and features calculation methods designated in advance. Then, the model generation unit 211 generates a new statistical model using the data obtained by the preprocessing.

The model generation unit 211 generates a hidden Markov model by using a known algorithm such as BaumWelch, for example. These algorithms are also useful for analyzing time-series data and generating hidden Markov models because they also include methods for automatically finding state change points. The model generation unit 211 is not limited to these algorithms, and may generate a statistical model using other known algorithms.

It should be noted that various patterns are specified for combinations of sensor data used for model generation among various sensor data included in the received training data, and for sensing conditions and filtering conditions. This specification may be specified by a person (model designer) or may be specified according to a predetermined rule. Therefore, the model generation unit 211 generates various statistical models in accordance with various specifications. That is, if the data acquired by the estimation device 100 in the collection mode is data about the disease X, the model generation unit 211 generates various statistical models 50 for estimating the disease X from the data acquired in the collection mode. The model generation unit 211 may generate at least one statistical model, and may not necessarily generate a plurality of statistical models.

When the statistical model generated by the model generation unit 211 is implemented in the estimation device 100, if resources such as memories are exhausted and the estimation device 100 cannot perform the computation, the function as the estimation device 100 cannot be appropriately provided. Therefore, the test unit 212 tests the statistical model generated by the model generation unit 211 in environments simulating the resources of the estimation device 100. That is, in order to ensure that the estimation device 100 can execute the estimation process based on the generated statistical model, the test unit 212 tests the statistical model.

Specifically, the test unit 212 simulates the estimation process using the statistical model generated by the model generation unit 211 in a virtual environment in which the calculation is performed with the same accuracy as the calculation accuracy of the MCU 101 of the estimation device 100. More specifically, the bit length for the calculation in the estimation device 100 and the bit length for the calculation in the virtual environment are made the same so that the calculation result in the estimation device 100 and the calculation result in the virtual environment are made the same.

The test unit 212 performs, for example, a simulation for performing an estimation process using the data acquired for model generation and the generated statistical model, or a simulation for performing an estimation process using data prepared in advance as data for verification and the generated statistical model. It should be noted that the test unit 212 may perform one of these simulations, or may perform both simulations. Then, the test unit 212 confirms that, for example, the occurrence of the state of the estimation target person to be estimated by the newly generated statistical model (i.e., the disease to be estimated by the statistical model) can be appropriately estimated by the new statistical model. Further, for example, the test unit 212 confirms that the new statistical model does not erroneously estimate that the state of the estimation target person to be estimated does not occur in the newly generated statistical model.

In particular, the test unit 212 performs not only a test using the database including only the model definition information of the new statistical model generated by the model generation unit 211 and the condition for acquiring the feature amount required for the estimation using the new statistical model, but also a test using the database in which the information on the new statistical model is added to the database 150 already possessed by the estimation device 100. In other words, the test unit 212 executes the test using the database including the model definition information of the new statistical model generated by the model generation unit 211 and the acquisition condition of the feature amount required for the estimation using the new statistical model, in addition to the acquisition condition of the model definition information and the feature amount stored in the data flash 123 of the estimation device 100. The condition for acquiring the feature amount required for the estimation using the new statistical model is specifically a sensor, a sensing condition, a filtering condition, and a feature amount calculation process which are designated in advance for the generation of the model. For this reason, even when updating is performed to add information about new statistical models to the existing database 150, it can be ensured that the estimation device 100 can perform appropriate estimation.

The test unit 212 may execute the test in an execution environment of the computation capability equal to or less than the computation capability of the estimation device 100. As a result, it is possible to guarantee that the estimation using the new statistical models can be performed by the calculation based on the calculation capability of the estimation device 100, for example, the process speed. In addition, for example, the test unit 212 may execute the test in an execution environment having a memory capacity equal to or smaller than the memory capacity of the estimation device 100. This ensures that the memory capacity of the estimation device 100 can also be estimated using new statistical models.

The test unit 212 may record the processing load and the memory capacity used in the estimation process for each generated statistical model. In the model generation stage, when calculation costs such as process loads and memory capacities can be estimated (for example, when algorithms capable of calculating costs such as Autoplait are used), the model generation unit 211 may record the calculation costs for each generated statistical model.

The distribution determination unit 213 selects information to be transmitted to the estimation device 100, and determines the device of the distribution destination of the selected information. As described above, the model generation unit 211 can generate a plurality of statistical models having different generation conditions as new models. Among the generated statistical models, the statistical models that have passed the test by the test unit 212, that is, the statistical models that are guaranteed to operate properly even in the environments of the estimation device 100, are candidates for the statistical models to be distributed. The distribution determination unit 213 selects which one of the candidates of the statistical model to be distributed is to be distributed. The distribution determination unit 213 may select a distribution target according to a designation by a person, for example, a business provider providing an estimation service, or may select a distribution target according to a predetermined rule. When selecting a distribution target according to a human specification, the distribution determination unit 213 may display and output a test result, an estimated accuracy, a calculation cost (e.g., a processing load, a memory capacity, etc.) of the test unit 212 on a display (not shown) for each statistical model generated by the model generation unit 211. The server 200 may transmit the information to another device connected to the server 200. The operator selects a distribution target based on the content output from the server 200, for example, and instructs the server 200.

As described above, the distribution determination unit 213 determines the information of the selected distribution target, that is, the model defining information defining the statistical model generated by the model generation unit 211 and the device of distribution destinations of the condition for acquiring the feature amount required for estimation using the statistical model. The distribution determination unit 213 is not limited to the estimation device 100 that has transmitted the data for generating the statistical models, and may determine another estimation device 100 as a distribution destination. The distribution determination unit 213 may determine the estimation device 100 of the distribution destination according to the specification by the user, or may determine the estimation device 100 of the distribution destination according to predetermined rules.

By the determination of the distribution target and the distribution destination by the distribution determination unit 213, the provider providing the estimation service can realize a desired distribution. The transmission/reception control unit 210 transmits the selected distribution target information as updated data to the estimation device 100 in accordance with the determination of the distribution determination unit 213.

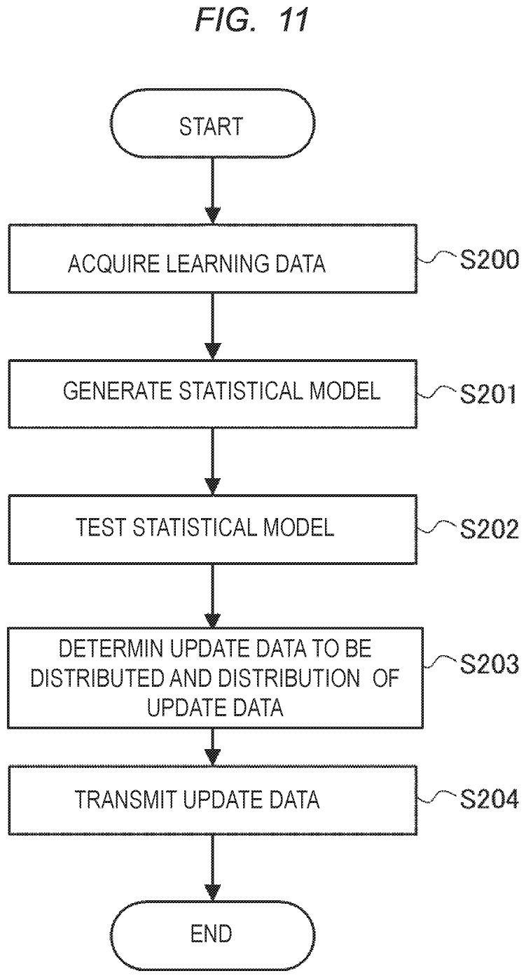

Next, the flow of the operation of the server 200 will be described. FIG. 11 is a flowchart showing the flow of the operation of the server 200. Hereinafter, the flow of the operation will be described with reference to FIG. 11.

In step 200 (S200), the transmission/reception control unit 210 acquires the learning data (data acquired by the data acquisition unit 160 of the collection mode) transmitted by the estimation device 100. Next, in step 201 (S201), the model generation unit 211 uses the learning data acquired in step 200 to generate a new statistical model. Next, in step 202 (S202), the test unit 212 tests the statistical models generated in step 201 in environments simulating the resources of the estimation device 100. Next, in step 203 (S203), the distribution determination unit 213 determines update data (a condition for acquiring model definition information and feature amounts) to be distributed, and determines a distribution destination of the update data. Next, in step 204 (S204), the transmission/reception control unit 210 transmits the updated data to the estimation device 100 according to the determination in step 203.

As described above, in the estimation device 100, when the calculated feature amount does not correspond to the existing statistical model, the mode is switched from the estimation mode to the collection mode, and the data can be acquired under an acquisition condition that differs from the acquisition condition in the estimation mode. Therefore, it is possible to acquire data for creating a model for estimating a new state that cannot be estimated by an existing model. The server 200 verifies the generated statistical models in an environment simulating the execution environment of the estimation device 100. Therefore, the operation of the estimation device 100 can be guaranteed.

In the above embodiment, it is assumed that the components shown in FIG. 7 and the components shown in FIG. 10 are realized by executing a program. However, some or all of these components may be implemented as processing of hardware circuitry.

The programs described above and those described below may also be stored and provided to a computer using various types of non-transitory computer-readable media. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory, a CD-R, a CD-R/W, solid-state memories (e.g., masked ROM, PROM (Programmable ROM), EPROM (Erasable PROM, flash ROM, RAM (Random Access Memory)). The program may also be supplied to the computer by various types of transitory computer-readable media. Examples of transitory computer-readable media include electrical signals, optical signals, and electromagnetic waves. The transitory computer readable medium may provide the program to the computer via wired or wireless communication paths, such as electrical wires and optical fibers.

Although the invention made by the inventor has been specifically described based on the embodiment, the present invention is not limited to the embodiment already described, and it is needless to say that various modifications can be made without departing from the gist thereof.

For example, some or all of the above embodiments may also be described as in the following Notes, but are not limited thereto.

(Note 1) An information processing device comprising: a storage unit storing model definition information defining a statistical model for each estimation type and an acquisition condition of a feature amount required for estimation using the statistical model; a data acquisition unit acquiring a feature amount from a sensor signal in a first mode according to the acquisition condition and acquiring data for generating a new statistical model from a sensor signal in a second mode according to a condition different from the acquisition condition; a determination unit determining whether the feature amount acquired by the data acquisition unit in the first mode satisfies a requirement defined by the model definition information; and a mode change unit changing a mode of the data acquisition unit from the first mode to the second mode according to a determination result by the determination unit that the feature amount does not satisfy the requirement.

(Note 2) The information processing device according to Note 1, wherein the model definition information includes information defining a range of the feature amount according to the estimated type, the determination unit determines whether the feature amount acquired by the data acquisition unit is within the range defined by the model definition information, and the mode changing unit changes a mode of the data acquisition unit from the first mode to the second mode according to a result of determination by the determination unit that the feature amount is not within the range.

(Note 3) The information processing device according to Note 2, wherein the statistical model has one or more internal states and the information defining a range of feature amounts corresponding to the estimation type further includes information defining a range of feature amounts for each the internal state, the model definition information further includes information defining a transition probability of the internal state, the decision unit is a first determination and a second determination, the first determination is a determination as to whether or not the feature amount obtained by the data acquisition unit is within the range defined by the model definition information, and the second determination is a determination of the degree of agreement between the transition probability of the internal state calculated based on the time series data of the feature amount acquired by the data acquisition unit during a predetermined period and the transition probability of the internal state defined by the model definition information, and the mode modifying unit changes the mode of the data acquisition unit from the first mode to the second mode in response to the result of the first determination or the second determination. (Note 4) The information processing device according to Note 2, claim the mode changing unit changes the mode of the data acquisition unit from the first mode to the second mode when the ratio of the determination result by the determination unit that the feature amount is not within the range among all the determination results by the determination unit with respect to the time-series data of the feature amount for a predetermined period satisfies a predetermined criterion.

(Note 5) The information processing device according to Note 3, claim the statistical model is a hidden Markov model.

(Note 6) The information processing device according to Note 1, wherein the storage unit stores the model definition information for each estimation type and a database for managing the acquisition condition, and the acquisition condition included in the database includes sensor specification information for specifying a sensor used for obtaining the sensor signals, a sensing condition for specifying a measuring condition of a sensor specified by the sensor specification information, and a filtering condition for specifying a condition of filtering processing for acquiring the feature amount.

(Note 7) The information processing device according to Note 6, further comprising a registering unit for registering updated data about the databases.

(Note 8) The information processing device according to Note 1, further comprising a sensor abnormality detecting unit for detecting an abnormality of a sensor, and wherein the mode changing unit changes a mode of the data acquisition unit from the first mode to the second mode in accordance with a result of determination by the determination unit that the feature amount does not satisfy the requirements only when the sensor abnormality detecting unit does not detect an abnormality of the sensor.

(Note 9) The information processing device according to Note 1, wherein the data acquisition unit acquires the feature amount from the sampling data of the sensor signal, and the first mode and the second mode differ in the sampling rate of the sensor signal.

(Note 10) The information processing device according to Note 9, claim the sampling rate in the second mode is a maximum value that can be set.

(Note 11) The information processing device according to Note 9, claim the sampling rate in the second mode is larger than the sampling rate in the first mode.

(Note 12) The information processing device according to Note 1, wherein the data acquisition unit performs filtering processing to acquire the feature amount, and the first mode and the second mode differ from each other in processing content of the filtering processing.

(Note 13) The information processing device according to Note 1, further including a transmission control unit that controls transmission of the data acquired by the data acquisition unit in the second mode to another device that performs a process of generating new statistical models.

(Note 14) The information processing device according to Note 1, further comprising an estimation unit that performs estimation based on the statistical models and the feature amounts.

(Note 15) The information processing device according to Note 14, claim the statistical model is a model for each type of disease, and the estimating unit estimates the occurrence of the disease in the living body.

(Note 16) The information processing device according to Note 1, further comprising a sensor for generating the sensor signals.

(Note 17) The information processing device according to Note 1, wherein the data acquisition unit acquires a feature amount from a plurality of sensor signals measured at the same time when the data acquisition unit acquires a feature amount in the first mode.

(Note 18) The information processing device according to Note 1, wherein the data acquisition unit acquires a plurality of feature amounts from one or more sensor signals in the first mode.

(Note 19) The information processing device according to Note 16, which has a function of restricting the supplying of electric power to the sensors which are unnecessary for generating the sensor signals in accordance with the obtaining condition, among the sensors provided in the information processing device.

(Note 20) An information processing device and a server, wherein the information processing device includes: a storage unit storing model definition information defining a statistical model for each estimation type and an acquisition condition of a feature amount required for estimation using the statistical model; a data acquisition unit acquiring a feature amount from a sensor signal in a first mode in accordance with the acquisition condition and acquiring data for generating a new statistical model from a sensor signal in a second mode in accordance with a condition different from the acquisition condition; a determination unit determining whether the feature amount acquired by the data acquisition unit in the first mode satisfies a requirement defined by the model definition information; and a mode change unit changing a mode of the data acquisition unit from the first mode to the second mode in accordance with a determination result by the determination unit that the feature amount does not satisfy the requirement, and a mode change from the first mode to the second mode in accordance with a determination result by the determination unit that the feature amount does not satisfy the requirement. An information processing system comprising: a model generation unit that performs a process of generating a new statistical model using data acquired by the data acquisition unit in the second mode; and a test unit that tests a statistical model generated by the model generation unit in environments simulating resources of the information processing device.

(Note 21) The information processing system according to Note 20, claim the test unit executes a test in an execution environment of a computing capability equal to or less than the computing capability of the information processing device.

(Note 22) The information processing system according to Note 20, claim the test unit executes a test in an execution environment of a memory capacity equal to or less than a memory capacity of the information processing device.

(Note 23) The information processing system according to Note 20, wherein the model definition information and the acquisition condition of the feature amount of the statistical model for each estimation type stored in the storage unit are managed by the database, and the test unit executes the test using the database including the model definition information of the new statistical model generated by the model generation unit and the acquisition condition of the feature amount required for the estimation using the new statistical model, in addition to the model definition information and the acquisition condition of the feature amount already stored in the storage unit.

(Note 24) The information processing system according to Note 20, wherein the server further includes a distribution determination unit that determines model definition information defining a statistical model generated by the model generation unit and a distribution destination device of a condition for obtaining a feature amount required for estimation using the statistical model.

(Note 25) A program for causing a computer to execute a data acquisition step of acquiring a feature amount from a sensor signal in a first mode according to the acquisition condition stored in a storage unit storing model definition information defining a statistical model for each estimation type and an acquisition condition of a feature amount required for estimation using the statistical model, and acquiring data for generating a new statistical model from a sensor signal according to a condition different from the acquisition condition in a second mode, a determination step of determining whether or not the feature amount acquired in the data acquisition step in the first mode satisfies a requirement defined by the model definition information, and a mode change step of changing the mode from the first mode to the second mode according to a determination result in the determination step of determining that the feature amount does not satisfy the requirement.

What is claimed is:

1. An information processing device comprising:
storage unit storing model definition information defining a statistical model for each estimation type and an acquisition condition of a feature amount required for estimation using the statistical model;
in a first mode, a data acquisition unit acquiring a feature amount from a sensor signal in accordance with the acquisition condition and acquiring data for generating a new statistical model from a sensor signal in accordance with a condition different from the acquisition condition in a second mode;
a determination unit determining whether or not the feature amount acquired by the data acquisition unit in the first mode satisfies a requirement defined by the model definition information; and
a mode change unit changing a mode of the data acquisition unit from the first mode to the second mode in accordance with a determination result by the determination unit that the feature amount does not satisfy the requirement.

2. The information processing device according to claim 1,
wherein the model definition information includes information defining a range of the feature amount according to the estimation type, the determination unit determines whether or not the feature amount acquired by the data acquisition unit is within the range defined by the model definition information, and the mode changing unit changes a mode of the data acquisition unit from the first mode to the second mode according to a result of determination by the determination unit that the feature amount is not within the range.

3. The information processing device according to claim 2,
wherein the statistical model has one or more internal states, the information defining the range of the feature amount according to the estimation type is information defining the range of the feature amount for each of the internal states, the model definition information further includes information defining the transition probability of the internal states, the determining section performs a first determination and a second determination, the first determination is whether or not the feature amount acquired by the data acquiring section is within the range defined by the model definition information, the second determination is a determination of a degree of coincidence between a transition probability of the internal state calculated based on time series data of the feature amount acquired by the data acquiring section during a predetermined period and the transition probability of the internal state defined by the model definition information, and the mode changing section changes the mode of the data acquiring section from the first mode to the second mode according to the result of the first determination or the second determination.

4. The information processing device according to claim 2,
wherein the mode changing unit changes the mode of the data acquisition unit from the first mode to the second mode when the ratio of the determination result by the determination unit that the feature amount is not within the range among all the determination results by the determination unit with respect to the time-series data of the feature amount for a predetermined period satisfies a predetermined criterion.

5. The information processing device as claimed in claim 3,
wherein the statistical model is a hidden Markov model.

6. The information processing device as claimed in claim 1,
wherein the storage unit stores the model definition information for each estimation type and a database for managing the acquisition condition, and the acquisition condition included in the database includes sensor identification information for identifying a sensor used for obtaining the sensor signals, a sensing condition for specifying a measuring condition of a sensor specified by the sensor identification information, and a filtering condition for specifying a condition of filtering processing for acquiring the feature amount.

7. The information processing device according to claim 6,
further comprising a registering unit for registering updated data about the databases.

8. The information processing device according to claim 1,
further comprising: a sensor abnormality detecting unit for detecting an abnormality of a sensor; and the mode changing unit changes a mode of the data acquisition unit from the first mode to the second mode in accordance with a result of determination by the determination unit that the feature amount does not satisfy the requirement only when the sensor abnormality detecting unit does not detect an abnormality of the sensor.

9. The information processing device according to claim 1,
wherein the data acquisition unit acquires the feature amount from sampling data of the sensor signal, and the first mode and the second mode differ in sampling rate of the sensor signal.

10. The information processing device according to claim 9,
wherein the sampling rate in the second mode is a maximum value that can be set.

11. The information processing device according to claim 9,
wherein the sampling rate in the second mode is larger than the sampling rate in the first mode.

12. The information processing device according to claim 1,
wherein the data acquisition unit performs filtering processing to acquire the feature amount, and the first mode and the second mode differ in processing content of the filtering processing.

13. The information processing device according to claim 1,
further comprising a transmission control unit that controls transmission of the data acquired by the data acquisition unit in the second mode to another device that performs a process of generating new statistical models.

14. The information processing device according to claim 1,
wherein the data acquisition unit acquires a feature amount from a plurality of sensor signals measured at the same time when the data acquisition unit acquires a feature amount in the first mode.

15. The information processing device according to claim 1,
wherein the data acquisition unit acquires a plurality of feature amounts from one or more sensor signals in the first mode.

16. An information processing system comprising: an information processing device and a server,
wherein the information processing device includes;
a storage unit storing model definition information defining a statistical model for each estimation type and an acquisition condition of a feature amount required for estimation using the statistical model;
a data acquisition unit acquiring a feature amount from a sensor signal in a first mode in accordance with the acquisition condition and acquiring data for generating a new statistical model from a sensor signal in a second mode in accordance with a condition different from the acquisition condition;
a determination unit determining whether the feature amount acquired by the data acquisition unit in the first mode satisfies a requirement defined by the model definition information; and
a mode changing unit changing the mode of the data acquisition unit from the first mode to the second mode in accordance with a determination result by the determination unit that the feature amount does not satisfy the requirement, and a mode changing unit changing the mode of the data acquisition unit from the first mode to the second mode using the data acquired by the data acquisition unit in the second mode,
wherein the server includes:
a model generating unit for performing a process of generating a new statistical model; and
a testing unit for testing the statistical model generated by the model generating unit in environments simulating resources of the information processing device

17. The information processing system according to claim 16,
wherein the test unit executes a test in an execution environment of a computing capability equal to or less than the computing capability of the information processing device.

18. The information processing system according to claim 16,
wherein the test unit executes a test in an execution environment of a memory capacity equal to or less than a memory capacity of the information processing device.

19. The information processing system according to claim 16,
wherein the model definition information of the statistical model and the acquisition condition of the feature amount for each estimation type stored in the storage unit are managed by a database, and the test unit executes a test using a database including model definition information of a new statistical model generated by the model generation unit and the acquisition condition of the feature amount required for estimation using the new statistical model, in addition to the model definition information and the acquisition condition of the feature amount already stored in the storage unit.

20. A program for causing a computer to execute comprising:
a data acquisition step of acquiring a feature amount from a sensor signal in a first mode in accordance with the acquisition condition stored in a storage unit storing model definition information defining a statistical model for each estimation type and an acquisition condition of a feature amount required for estimation using the statistical model, and acquiring data for generating a new statistical model from a sensor signal in a second mode in accordance with a condition different from the acquisition condition,
a determination step of determining whether or not the feature amount acquired in the data acquisition step in the first mode satisfies a requirement defined by the model definition information, and
a mode change step of changing a mode from the first mode to the second mode in accordance with a result of the determination in the determination step of determining that the feature amount does not satisfy the requirement.
